(19) United States
(12) Patent Application Publication
(10) Pub. No.: US 2022/0300971 A1
(43) Pub. Date: Sep. 22, 2022

(54) SELECTIVE TRANSACTION AUTHORISATION METHOD AND SYSTEM

(71) Applicant: MASTERCARD INTERNATIONAL INCORPORATED, Purchase, NY (US)

(72) Inventors: Michael John COWEN, Uffculme (GB); Bryn Anthony ROBINSON-MORGAN, Mosborough Village (GB); Daniel Anthony JOHNSON, Hutton (GB)

(73) Assignee: MASTERCARD INTERNATIONAL INCORPORATED, Purchase, NY (US)

(21) Appl. No.: 17/694,240

(22) Filed: Mar. 14, 2022

(30) Foreign Application Priority Data
Mar. 16, 2021 (GB) 2103612.4

(51) Int. Cl. G06Q 20/40; G06Q 30/02

(52) U.S. Cl. CPC G06Q 20/4014; G06Q 20/405; G06Q 20/407; G06Q 30/0239

(57) ABSTRACT

A selective transaction authorization method and system wherein the payment authorization request includes restriction information indicating a restricted purchase is requested, and the payment authorization request is declined or authorized according to a status of the account with which the purchase is being attempted.

### FIELD OF THE INVENTION

The present invention relates to a selective transaction authorization method and system and finds particular, although not exclusive, utility in providing a method and system for selectively authorizing restricted purchases.

### BACKGROUND TO THE INVENTION

Typically, when a card transaction is attempted, a payment authorization request is generated at a merchant terminal. The payment authorization request is then passed from the merchant to an acquirer, from the acquirer to the relevant card network and then ultimately to the relevant card issuer. The payment authorization request typically includes information identifying the merchant and the purchaser and some further information related to the transaction such as the total cost. The issuer must authorize or decline the transaction based on the information provided by the merchant.

It is known for a recipient of social security benefits, or other monetary benefits, to be provided with a debit card with which the benefit recipient may access their benefit funds. Paying benefits with such a debit card may be preferable to a cheque which requires paying in at a bank. The term ‘debit card’ is taken here to include both those which may be prepaid and topped up with the benefit amount and those which may give access to a bank account that receives the benefit amount as a direct debit or otherwise. Typically, a government or other benefit granting institution may wish to apply some restriction on the goods and/or services on which benefit funds may be spent. For example, a social benefit card may be provided to a vulnerable individual and give said individual access to benefit funds for the purchase of healthy items and essential goods and services. The benefit provider may wish to prevent the benefit funds from being spent on items, such as alcohol and tobacco products, not deemed to be healthy or essential items. To do so, the card issuer may be instructed to decline all payment authorization requests received from merchants known to sell items not deemed to be healthy or essential items.

However, some merchants, such as supermarkets and grocery stores, offer for sale both healthy and essential items and those items not deemed to be healthy or essential. Accordingly, a cardholder, such as social benefit card holder, may be prevented from spending their benefit funds in supermarkets and grocery stores, even if they are attempting to buy healthy or essential items. Alternatively, the card may be used for purchases from merchants that offer for sale both healthy and essential items and those items not deemed to be healthy or essential but the benefit provider must rely upon the cardholder to not purchase items not deemed to be healthy or essential. Neither of these typical solutions are considered to be convenient and effective for both cardholders and benefit providers.

Therefore, it is desirable to provide a selective transaction authorization method and system to alleviate at least these problems. Objects and aspects of the present invention seek to provide such a system and method.

### SUMMARY OF THE INVENTION

According to a first aspect of the present invention, there is provided a selective transaction authorization method comprising: receiving a payment authorization request, wherein the payment authorization request includes restriction information indicating a restricted purchase is requested; determining a status of an account being used to make the transaction; and declining the payment authorization request if the status of the account does not meet a requirement of the restricted purchase, or authorizing the payment authorization request if the status of the account does meet the requirement of the restricted purchase.

A key advantage of the present invention is that a transaction authorization request may be approved if the account holder is authorized to make the restricted purchase or declined if the account holder is not authorized to make the restricted purchase, as indicated by the status of their account.

The method may be carried out, at least partially, by an issuer. For example, the payment authorization request may be received by an issuer. Other steps of the method may be carried out by the issuer or a third party.

Selective transaction authorization may mean selectively authorizing or declining a payment authorization request. Accordingly, an issuer or other party may authorize or decline a payment authorization request with use of the present invention.

Restriction information may be information or details related to a limitation or other control placed on the transaction. For example, the transaction may be subject to an 18+ age restriction and the restriction information may indicate this age restriction. Accordingly, a restricted purchase may be a purchase subject to any such restriction. The requirement of the restricted purchase may be that the purchaser must be at least 18 years of age.

The status of the account may, for example, indicate that the account holder is not authorized to purchase items with an 18+ age restriction. As a further example, the status of the account may indicate that the account holder is a student and is therefore entitled to student discount. Accordingly, a payment authorization request indicating a student discount has been applied may be authorized if the account holder is entitled to student discount.

Items subject to the payment authorization request may be included in a basket. The basket may refer to the collection of items being purchased.

The restriction information may include age verification information. The age verification information may indicate an item subject to the payment authorization request is age-restricted. An age-restricted item may have, for example, an 18+ age rating such that only those individual aged 18 or older may legally purchase the item. Other age ratings, such as 16+, 21+ and 25+ are typically known. The age verification information may specify only that the basket includes or does not include an age-restricted item. The payment authorization request may be declined if the status of the account indicates that the account cannot be used to purchase age-restricted items. For example, the status may indicate that the account holder is aged 15. Accordingly, the account holder may not legally purchase items subject to a 16+, 18+, 21+ or 25+ age rating. As a further example, a social benefit cardholder may not be authorized to use their social benefit card to purchase alcohol or tobacco products, both items subject to an age rating in most jurisdictions such as 18+ in the United Kingdom. As such, barring the cardholder from purchasing age-restricted items may prevent the cardholder from purchasing alcohol or tobacco products. In this way, the cardholder may still use their social benefit card to purchase items from merchants, such as supermarkets and grocery stores, that sell both healthy and essential items and items not deemed to be healthy or essentials. This substantially increases the number of merchants through which a cardholder may make purchases and therefore improves the ease of use of such cards.

The age verification information may indicate a highest age requirement for an item or a collection of items subject to the payment authorization request. For example, if a basket includes an item subject to a 16+ age rating and an item subject to an 18+ age rating, the age verification information may indicate an 18+ rating for the basket. The age verification information may not include any indication of a 16+ rated item in the basket. Alternatively, the age verification information may indicate that both a 16+ rated item and an 18+ rated item are included in the basket.

The restriction information may include discount information. The discount information may indicate a discount is requested. For example, the discount information may indicate a student, association, employee or military discount is requested. The payment authorization request may be declined if the status of the account indicates the account does not qualify for the discount. The status of the account may indicate that the account holder is a student, a member of the military, or that the account holder meets some other criteria required to be eligible for the discount. If the status of the account indicates the account does not qualify for the discount, a check may be made with a third party to verify whether or not the account holder is entitled to the requested discount, for example by means of a call to an Application Programming Interface (API). For example, a cardholder may request a discount based on membership of an organization and a list of members of the organization may be referenced to see if the cardholder is a member of said organization.

The restriction information may be generated by a point-of-sale system. Typically, when scanning an item subject to an age-restriction at a point-of-sale, an alert is generated to prompt an operator of the point-of-sale to verify a customer's age. This information is typically not used in further processing after the point-of-sale operator verifies the customer's age. However, the present invention may make use of this information by incorporating the information in the payment authorization request to allow an issuer to approve or decline the purchase based on the age-restricted nature of the item. The point-of-sale system may be a physical point-of-sale system or an online point-of-sale system.

The selective transaction approval method may further comprise generating and sending an alert if the payment authorization request is declined. Alternatively or additionally, an alert may be generated and sent if an attempt to purchase an age-restricted item or items has been made. Such an alert may be sent regardless of the authorization decision. The alert may comprise an app alert, an SMS message, an email and/or another suitable alert. The alert may be sent to a party other than a holder of the account being used to make the transaction. Accordingly, a caregiver, parent or other authoritative individual or organization may be informed the cardholder has attempted to purchase a restricted item.

The selective transaction approval method may further comprise receiving a response to the alert. The alert may include a link or other means for the alert recipient to respond to the alert. As such, if a third party such as a parent or caregiver receives an alert that the cardholder has attempted to make a restricted purchase, they may give their authorization for a subsequent restricted payment to be authorized. The selective transaction approval method may further include authorizing a further payment authorization request. Accordingly, a subsequent payment authorization request including the same restriction may be approved.

The restriction information may be provided in the absence of data that identifies individual products in the basket such as Stock Keeping Unit level data, typically known as SKU level data. SKU level data may be data typically included in a barcode or other item identification code and may allow a holder of SKU level data to determine the type and quantity of product. As such, no specific data related to the items being purchased may be provided with the restriction information. In this way, only the fact that an item or the purchase is restricted may be provided. Merchants may therefore not be required to share information related to the items being purchased. Furthermore, an issuer may not be required to process basket data to determine whether the basket includes a restricted item. The merchant will typically complete this basket checking process prior to submitting the payment authorization request and this work output may be reused by the issuer.

The restriction information may be provided as a single byte. For example, a single byte of the payment authorization request message may indicate the purchase is subject to a restriction, such as including an age-restricted item. The single byte of data may specify to which restriction the purchase is subject. For example, the single byte of data may specify that an age-restricted item is included in the basket or that a discount is sought. As a further example, the single byte of data may specify ‘0’ for no age-restriction data being provided, ‘1’ for no age-restricted items in the basket, ‘16’ for at least one item in the basket requires the purchases to be age 16+, or ‘18’ for at least one item in the basket requires the purchases to be age 18+. Other numbers of categories and data types are envisaged.

The payment authorization request may include restriction categorization information to categorize the restricted purchase into one or more restriction categories. The restriction categories may be predetermined. An account holder may be authorized to purchase items in a first of the one or more restriction categories but may not be authorized to purchase items in a second of the one or more restriction categories. Accordingly, the payment authorization request may be approved if the restricted item falls within the first of the one or more restriction categories and declined if the restricted item falls within the second of the one or more restriction categories. For example, the first of the one or more restriction categories may include petrol and other automotive fuels, whereas the second of the one or more restriction categories may include lottery tickets and scratch cards. Each of these items are subject to a 16+ age restriction in the United Kingdom. Therefore, a cardholder may be authorized to purchase petrol, which may be deemed essential, whilst being unable to purchase a lottery ticket, which may not be deemed essential. If no restriction categorization information is provided, the cardholder may not be authorized to purchase petrol or a lottery ticket.

The restriction categorization information may be provided as a single byte. For example, the single byte of data may specify ‘1’ for the first of the one or more predetermined restriction categories and ‘2’ for the second of the one or more predetermined restriction categories. Other numbers of categories and data types are envisaged.

The payment authorization request may include a merchant identifier. The method may further comprise declining the payment authorization request if the merchant identifier is not included in a predetermined list of approved merchants. Accordingly, a predetermined list, or ‘white-list’ of approved merchants may be provided. As such, payment authorization requests received from merchants that are not pre-approved may be declined. This predetermined list may comprise merchants that are known to populate the restriction information value, for example, merchants whose point of sale systems automatically detect that a given age verification check is required and incorporate the ‘required age’ into the authorization request message.

The selective transaction approval method may further comprise fulfilling a transaction if the payment authorization request is approved. In this way, a payment may be made from a payer's account to a payee's account.

According to a second aspect of the present invention, there is provided a computer readable storage medium system configured to store computer executable code that when executed by a computer configured to carry out the method of the first aspect of the present invention. In this way, the system may be used to selectively decline or authorize a transaction authorization request based, at least in part, on a status of the payer's account. A benefit granting institution may therefore impose some restriction on the goods and/or services for which the account may be used to make purchases.

### BRIEF DESCRIPTION OF THE DRAWINGS

FIG. 1 is a first schematic process diagram showing a method of selectively authenticating a restricted transaction; and

FIG. 2 is a second schematic process diagram showing a method of selectively authenticating a transaction including an age-restricted item.

### DETAILED DESCRIPTION

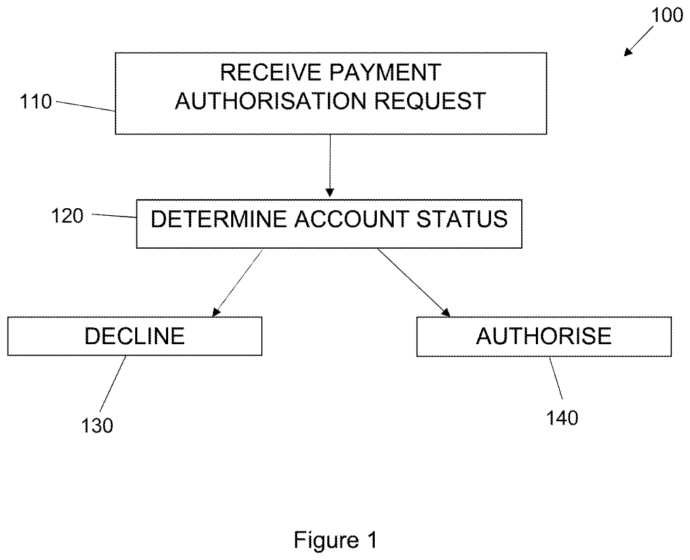

FIG. 1 is a first schematic process diagram showing a method 100 of selectively authenticating a restricted transaction. A card issuer may receive a payment authorization request 110 from a merchant via an acquirer and relevant card network. The payment authorization request 110 will typically include information identifying the merchant and the account from which payment is intended, and some further information related to the transaction such as the total cost.

Furthermore, the payment authorization request 110 includes restriction information indicating the payment authorization request 110 is for a restricted transaction. A restricted transaction may be, for example, a purchase of an age-restricted item or a purchase including a student discount. The restriction information may be provided as a single byte in the payment authorization request. The single byte of data may specify to which restriction the purchase is subject. For example, the single byte of data may specify that an age-restricted item is included in the basket or that a discount is sought. As a further example, the single byte of data may specify ‘0’ for no age-restriction data being provided, ‘1’ for no age-restricted items in the basket, ‘16’ for at least one item in the basket requires the purchases to be age 16+, or ‘18’ for at least one item in the basket requires the purchases to be age 18+.

The restriction information may be provided without the need for SKU level data. Accordingly, the issuer may simply be told that some restriction applies and may not be provided with any information indicating the nature of goods and/or services purchased. For example, the issuer may be informed the transaction relates to an item that is subject to an 18+ age-rated, without specifying what the item is.

As noted above, the payment authorization request 110 typically includes some information to identify the account with which the transaction is to be made. The issuer, after receiving the payment authorization request 110, may then retrieve and/or determine a status of the account 120. The account may be a student account and, as such, the status of the account 120 may indicate a student discount may be given. Alternatively, the account may be a social benefit account and the account holder may only use the account to purchase items deemed to be healthy or essential. As such, the account holder may be barred from using the account to purchase alcohol and tobacco products by preventing the account from being used to purchase items with an 18+ age rating in the United Kingdom (or equivalent age rating in another jurisdiction).

The issuer may then use the account status 120 and the restriction information included in the payment authorization request 110, alongside the typical procedures, to decline 130 or authorize 140 the payment authorization request 110. If the payment authorization request 110 is authorized 140, the issuer may fulfil the transaction.

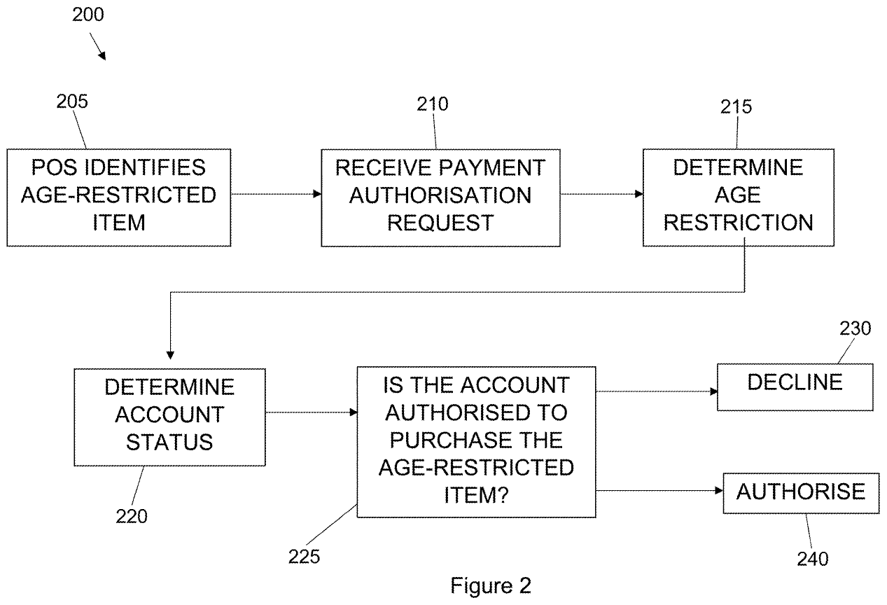

FIG. 2 is a second schematic process diagram showing a method 200 of selectively authenticating a transaction including an age-restricted item. When a customer wishes to purchase an item in a store, they will typically take their item to a point-of-sale system (POS) such as a checkout till. The POS operative, or the customer in a self-service environment, scans a barcode, QR code or other code with the POS. The POS then retrieves SKU level data related to the item such as price and if any age restriction applies. If, for example, alcohol is scanned at the POS, an alert or notification will be generated to inform the operative that the customer's age must be verified as being 18+ to fulfil legal requirements. Several items may be scanned at the POS and form a single transaction, if appropriate.

As noted above, when alcohol is scanned at the POS, data is created identifying an age restriction applies to the purchase. Typically, once a customer's age has been verified, the restriction data is not used in further processing. However, the restriction data may instead be included in a payment authorization request 210 sent to and received by the issuer as a transaction is attempted to pay for the items scanned at the POS. For example, a single byte of the payment authorization request 210 may indicate that the customer's basket is subject to an 18+ rating. Once the issuer receives the payment authorization request 210, the request may be analysed to determine an age restriction 215 applies to the basket. Accordingly, the issuer is informed at least one item in the customer's basket is subject to an age restriction without being provided with SKU level data.

Although the customer's age would have been verified by the store to fulfil legal requirements, the issuer may have alternative reasons for wishing to prevent the cardholder from purchasing items rated 18+. For example, the account may be a social benefit account that may only be used to purchase healthy and essential items and not alcohol. Accordingly, barring the cardholder from using the account to purchase items rated 18+ may prevent the cardholder from using the account to purchase alcohol.

The issuer may analyse or refer to a database or lookup table to determine the account status 220. The account status 220 may indicate that the cardholder may or may not purchase items that are restricted for sale only to those over a certain age. Accordingly, based on the determined account status 220, a determination is made as to whether the account is authorized to purchase a basket which includes the age-restricted item 225. This determination may then be used alongside typical and conventional payment authorization request decision making procedures.

If the account is not authorized to purchase the age-restricted item, the payment authorization request may be declined 230. Alternatively, if the account is authorized to purchase the age-restricted item, the payment authorization request may be authorized 240 and a payment fulfilled.

Although not described with reference to FIGS. 1 and 2 above, additional steps may be undertaken when declining or authorizing a payment authorization request as will be clear from the disclosures herein. Furthermore, although some discussion of the content of a payment authorization request is discussed herein, additional or alternative information may be provided in the payment authorization request. Several examples of restricted purchases and account statuses, such as age-restricted or student discount eligible, are described, other restrictions and statuses are envisaged. Furthermore, following the decline or authorization of the payment authorization request, additional steps may be undertaken.

A sequence of steps carried out to generate a payment authorization request at a point-of-sale system are discussed above. However, additional or alternative steps are envisaged. For example, an online transaction may be attempted. Additionally, although the restriction information may be provided as a single byte, more than one byte may be used to provide the restriction information. For example, a first byte may be used to indicate an 18+ rated item is being purchased and a second byte may be used to indicate the 18+ rated item falls into a category containing alcohol.

1. A selective transaction authorization method comprising:
receiving a payment authorization request, wherein the payment authorization request includes restriction information indicating a restricted purchase is requested;
determining a status of an account being used to make the transaction; and
declining the payment authorization request if the status of the account does not meet a requirement of the restricted purchase, or authorizing the payment authorization request if the status of the account does meet the requirement of the restricted purchase.

2. The selective transaction approval method of claim 1, wherein the restriction information includes age verification information indicating an item subject to the payment authorization request is age-restricted, and wherein the payment authorization request is declined if the status of the account indicates the account cannot be used to purchase age-restricted items.

3. The selective transaction approval method of claim 2, wherein the age verification information indicates a highest age requirement for an item or a collection of items subject to the payment authorization request.

4. The selective transaction approval method of claim 1, wherein the restriction information includes discount information indicating a discount is requested, and wherein the payment authorization request is declined if the status of the account indicates the account does not qualify for the discount.

5. The selective transaction approval method of claim 1, wherein the restriction information is generated by a point-of-sale system.

6. The selective transaction approval method of claim 1, further comprising generating and sending an alert if the payment authorization request is declined.

7. The selective transaction approval method of claim 6, wherein the alert is sent to a party other than a holder of the account being used to make the transaction.

8. The selective transaction approval method of claim 6, further comprising receiving a response to the alert and authorizing a subsequent payment authorization request.

9. The selective transaction approval method of claim 1, wherein the restriction information is provided in the absence of SKU level data.

10. The selective transaction approval method of claim 1, wherein the restriction information is provided as a single byte.

11. The selective transaction approval method of claim 1, wherein the payment authorization request includes restriction categorization information to categorize the restricted purchase into one or more restriction categories.

12. The selective transaction approval method of claim 11, wherein the restriction categorization information is provided as a single byte.

13. The selective transaction approval method of claim 1, wherein the payment authorization request includes a merchant identifier and the method further comprises declining the payment authorization request if the merchant identifier is not included in a predetermined list of approved merchants.

14. The selective transaction approval method of claim 1, wherein the method further comprises fulfilling a transaction if the payment authorization request is approved.

15. A computer readable storage medium system configured to store computer executable code that when executed, cause a computer to:
receive a payment authorization request, wherein the payment authorization request includes restriction information indicating a restricted purchase is requested;
determine a status of an account being used to make the transaction; and
decline the payment authorization request if the status of the account does not meet a requirement of the restricted purchase, or authorize the payment authorization request if the status of the account does meet the requirement of the restricted purchase.

16. The computer readable storage medium of claim 15, wherein the restriction information includes age verification information indicating an item subject to the payment authorization request is age-restricted, and wherein the payment authorization request is declined if the status of the account indicates the account cannot be used to purchase age-restricted items.

17. The computer readable storage medium of claim 16, wherein the age verification information indicates a highest age requirement for an item or a collection of items subject to the payment authorization request.

18. The computer readable storage medium of claim 15, wherein the restriction information includes discount information indicating a discount is requested, and wherein the payment authorization request is declined if the status of the account indicates the account does not qualify for the discount.

19. The computer readable storage medium of claim 15, wherein the restriction information is generated by a point-of-sale system.

20. The computer readable storage medium of claim 15, wherein the restriction information is provided in the absence of SKU level data.
